(19) United States
(12) Patent Application Publication
(10) Pub. No.: US 2023/0301443 A1
(43) Pub. Date: Sep. 28, 2023

(54) Method and Kit for Anti-Roll Travel Support Pillow for Children

(71) Applicant: Vandester Jenkins, Fayetteville, GA (US)

(72) Inventor: Vandester Jenkins, Fayetteville, GA (US)

(21) Appl. No.: 17/887,015

(22) Filed: Aug. 12, 2022

Related U.S. Application Data
(60) Provisional application No. 63/372,665, filed on Mar. 25, 2022.
(60) Provisional application No. 63/372,666, filed on Mar. 25, 2022.

(51) Int. Cl. A47D 15/00

(52) U.S. Cl. CPC A47D 15/006

(57) ABSTRACT

The disclosed inventive concept comprises a kit containing an anti-roll travel support pillow for use by children and toddlers when strapped into a car safety seat. Variably-sized travel support pillows are fabricated with an integral, sewn-in loop fastener and an integral, sewn-in combination fastener. A child's head frequently bobs uncontrollably while sleeping in a car safety seat. The travel support pillow ensures an added step of child safety when infants or toddlers occupy a child's car safety seat in a vehicle. Included within the kit are a stand-alone fixed hook-fastener and a stand-alone fixed combination fastener, each of which must be manually affixed to a car safety seat. This enables attachment of the travel support pillow onto the left and right outer surfaces of the child safety seat. A cushioned interior of the travel support pillow stabilizes the child's or infant's head while the vehicle is in motion.

### CROSS-REFERENCES TO RELATED APPLICATIONS

This application claims the benefit of priority from previously-filed U.S. provisional patent application, Ser. No. 63/372,665, filed on Mar. 25, 2022. This application also claims the benefit of priority from previously-filed provisional patent application, Ser. No. 63/372,666, filed on Mar. 25, 2022 and further, claims the benefit of the content of both said provisional patent applications as though fully appearing herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The field of the present inventive concept relates generally to a method, systems, and equipment utilized to protect and stabilize the neck and head of a newborn baby, an infant, or a child while the child is enclosed in a child safety seat within a moving vehicle. For this disclosure, the term “Child safety seat” includes an infant safety seat, child seat, baby seat, and car seat. This inventive concept is designed as a method using specific components to assist in preventing unnecessary movement of a child's head while the child is strapped in a child safety seat within a motor vehicle or an aircraft.

In this document, the term “infant,” for the purposes of this disclosure, is defined as a very young child or baby. The meaning of “child” is defined as “a young person especially between infancy and puberty” www.merriam-websier.com. Specifically, the children for whom this inventive concept is intended may hypothetically be in the range from infancy to 8 years of age. The terms “infant” and “toddler” are used to generally distinguish the relative size and age at various stages of child development.

Seat belts are designed to fit adults. Specifically, seat belts are designed to support the body in a crash by distributing the energy of a crash's impact so it does not hit the passengers' body all at once. Even at low speeds, crash forces in an accident can approach more than 30 G's (where one “G” is equivalent to the gravitational pull of the Earth). By comparison, fighter pilots are able to sustain up to 9 G's for brief periods of time, with the assistance of specially-designed “G-suits,” which prevents blood from pooling in their legs and abdominal area during flight maneuvers. Automotive seat belts grip the body by its strongest points—the hips, shoulders, and rib cage.

Unfortunately, normal seat belt designs do not accommodate the much smaller size of infants and toddlers. Because of this design factor (or flaw), the National Highway Traffic Safety Administration (NHTSA) recommends children be in booster seats or car child safety seats until the age of 12. This is further modified, under circumstances when the child reaches at least 4-feet-9-inches tall, which is the height at which a person can safety use a seat belt.

Even with the recommendations of car seats or booster seats for smaller framed individuals, there is an area of the body of an infant or child that is not completely protected in the event of a crash, or even during normal, routine operations of a vehicle. Children often fall asleep during car rides. During their periods of sleep while traveling, the chest restraints do not prevent the head from ‘bobbing’ during the vehicle's motion. Typical travel pillows have been used to stabilize the larger individual's head movement but have not been proven reliably stable during vehicle crashes. The author has observed, during extended automobile trips, that an infant needs a more stable and reliable means to immobilize the infant's or child's head, yet providing comfort during travel.

### OBJECTS OF THE INVENTION

The primary reason for this inventive concept is to provide parents with a travel kit 2 (the kit 2 being essentially packaging or boxing) that can be deployed by attaching fasteners and a travel support pillow to a child safety seat. In this manner, an additional level of protection is given to a child, toddler, or infant's neck, spine, and head area in the event of any unforeseen incident or accident, while traveling in a motor vehicle.

Another objective is to provide comfort to a child in sleep, protecting his/her head from sudden side-to-side rolling motion during normal motor vehicle traveling.

An additional purpose of this invention is to provide parents with peace of mind While traveling with their children or infants and/or toddlers for which they are responsible for transporting. A commonly used phrase in this document is the term, “child,” which refers to youth from newborn to pre-teen children.

### (2) Description of the Related Art, including information disclosed under 37 CFR 1.97 and 1.98.

U.S. Patent Application No. 2019/0008280 A1; Buch; Jan. 10, 2019. Neck Pillow, a Prior Art, is a U-shaped Soft Surface, provides head support and thus helps napping. Anchored Pilo improves the quality of the bead support provided by Neck Pillow. Anchored Pilo expands the use of Neck Pillow (and other Soft Surfaces) by anchoring it. An adjustable length Strap is used for anchoring. The Length adjustability makes Anchored Pilo usable for chairs and people of different dimensions. A Neck Pillow with Strap can still be used as Neck Pillow when the Strap is not used for anchoring.

U.S. Patent Application No. 2012/0217786 A1; Kim; Aug. 30, 2012. A support device for a vehicle child seat belt tightens the shoulders and the abdominal area of a child using the existing vehicle seat belt as it is in a state where the vest type support device is easily worn on the body of the child, and which includes a cushion body for fastening the entire front face of the body of the child and an auxiliary belt for preventing the child from upwardly or downwardly escaping from the seat belt. The vehicle child seat belt support device includes: a shock-preventing cushion body formed to surround a child's body and having a seat belt receiving part formed on a front face thereof in such a fashion that the seat belt is detachably accommodated in the seat belt receiving part.

U.S. Patent Application No. 2005/02641055; Lincoln, M.; Dec. 1, 2005. A children's pillow adapted for use with a children's car seat comprising: (a) a central area adapted to receive at least a rearward portion of a child's head; (b) a first lateral wing extending from the central area; (c) a second lateral wing extending from the central area; (d) a neck support region; and (e) a retainer adapted to mount the children's pillow to the children's car seat, where the neck support region extends between the first lateral wing and the second lateral wing.

U.S. Patent Application; 2005/0015881 A1; Littlehorn, S. Jan. 27, 2005. A neck pillow system comprises a neck pillow comprising a pillow body having a medial region and two arms that each have an end. The arms extend from the medial region to form a generally open well, and the neck pillow is configured to be placed around a baby's neck, with the medial region being positioned at the baby's back and the two ends positioned at the baby's front. A bib is removably coupled to the pillow body near each of the ends to permit the bib to hang vertically down over the baby's chest.

U.S. Patent No. 2007/0052274 A1; Morphew et al; Mar. 8, 2007. A car seat pillow is in the form of an elongated, generally cylindrically shaped pillow casing filled with pillow stuffing. Each end face of the pillow is provided with an attaching element to adjustably attach the pillow to the support frame of a car seat. Each attaching element may include a flexible strap for releasable engagement with a corresponding shoulder strap guide formed on the sides of a car seat.

U.S. Patent No. 2021/27839 A1; Recchia, D.; May 6, 2021. The invention relates to a travel pillow (10) which is designed as an essentially U-shaped neck pillow and has a first leg (12) and a second leg (14), which are connected by a central part (16), the first leg (12) terminating in a first leg tip (22) and the second leg (14) terminating in a second leg tip (24), and the travel pillow (10) having a circumferential inner side and a circumferential outer side and a top side (18), a bottom side (20) and a central plane (M), characterized in that the travel pillow (10) has a reinforcing strip (30) which extends from the first leg (12) through the central part (16) to the second leg (14).

U.S. Patent Application No. 2015/0216335 A1; Schwingendorf et al; Aug. 6, 2015. The embodiments disclosed are related to a supportive head and neck pillow with a supportive bone structure inside the pillow. The pillow is used for head and neck support, and comfort while sleeping sitting up during transportation. It can also be used for head and neck support for people who have neck injuries, or to prevent neck injuries during transportation. The sleepy heads neck pillow disclosed comprises a pillow with a bone structure support inside it.

### BRIEF SUMMARY OF THE INVENTION

The disclosed inventive concept comprises a kit having at least one variably-sized travel pillow, each pillow fabricated with a sewn-in loop fastener 12(a) and a sewn-in combination fastener 16(a). Further, a fixed hook fastener 12 and a fixed combination fastener 16 are provided. The sewn-in loop fastener 12(a) and sewn-in combination fastener 16(a) are located on the inner side of the travel pillows so as to enable the convenient attachment to correspondingly-mated fixed hook fasteners and fixed combination fasteners. The fixed hook fastener and the fixed combination fastener are designed to be affixed to the left and right frontal vertical surfaces of a child safety seat. The components of the inventive concept are provided in the form of a travel kit 2.

The first level of motor vehicle safety for children is provided by the vehicle's installed seat belt. Because of a child's smaller size, a second level of safety, being an infant's or child's safety seat 8, 9 must be utilized in order to ensure the security and safety of any small person, during transportation. Prior Art infant's safety seat 8, and child's safety seat 9, shown in FIG. 2 and FIG. 2A, each illustrates this second level of safety and security within a motor vehicle, along with the added support of the vehicle's installed seat belt.

The present inventive concept overcomes the shortcomings of the standard infant car seat by providing an additional safety feature to an area of the body, specifically, proximate the head and neck area of an infant, that has been difficult to protect, even with the use of an infant's car seat or toddler's booster seat.

### BRIEF DESCRIPTION OF THE VIEWS OF DRAWINGS AS EXEMPLARY EMBODIMENTS OF THE INVENTIVE CONCEPT

FIG. 1 Is an illustration of a “prior art” device, referred to as infant safety seat 8. FIG. 1 serves to provide an overall indication of the general structure of infant safety seats.

FIG. 1 A illustrates a “prior art” toddler's safety seat 9, conventionally used for secure, protective seating of a child, said child defined as having matured and grown from the infant stage.

FIG. 2 presents a frontal view of an infant safety seat 8, further showing an infant 10 strapped into the infant safety seat 8.

FIG. 2A illustrates a view of a child, or toddler's safety seat 9, further showing a toddler 10(a) being secured within the toddler's safety seat 9.

FIG. 3 shows a view of the outer surfaces of an embodiment of the travel support pillow designated as an “oval-contoured travel pillow 20.”

FIG. 3A presents a cross-sectional view of the oval-contoured travel pillow 20, as seen from section line 3-3 of FIG. 3.

FIG. 3B illustrates a view of the inner surfaces of an oval-contoured travel pillow 20, generally to be used in conjunction with an infant's safety seat 8, to ensure stability of the head area of the infant 10.

FIG. 4 depicts the separation of a protective covering 14 from an adhesive layer 7, connected to a binding strip 13 and the hook component 6 of hook-and-loop fastening mechanism. There is thereby formed a standalone fixed combination fastener 16.

FIG. 4A presents simultaneous side views of a protective covering 14 having been separated from the adhesive layer 7 of a fixed combination fastener 16 and its integral male snap 3, along with a male snap 3.

FIG. 4B presents simultaneous cross-sectional views of a protective covering 14, having been separated from a fixed hoop fastener 12. The rightmost illustration of FIG. 4B depicts a cross-sectional view of a sewn-in loop fastener 12(a) sewn onto to the left concave arm 25 of an oval-contoured travel pillow 20.

FIG. 5 illustrates a different embodiment of the travel support pillow 1, designated as a “dish-shaped travel pillow 30. Shown is a planar rear view of the outer surfaces 34(a), 35(a) of the right shoulder 34 and left shoulder 35 of the dish-shaped travel pillow 30.

FIG. 5A depicts a cross-sectional view of the dish-shaped travel pillow 30, as seen from the perspective of section lines 5-5 of FIG. 5. Also in view is stitching 32 utilized for attachment of a sewn-in combination fastener 16(a) to the inner surface 34(b) of the right shoulder 34 of the dish-shaped travel pillow 30.

FIG. 6 indicates a typical infant safety seat 8, further showing the adhesively-attached locations of a fixed combination fastener 16 with a female snap 4, on the right-side frontal surface of the infant safety seat 8, and a fixed hook fastener 12 (attached by adhesive backing), affixed to the left-side frontal surface of the infant safety seat 8.

FIG. 6A displays a typical toddler's safety seat 9, further showing the locations of a fixed combination fastener 16 with its female snap 4, on the right-side frontal surface of the toddler's safety seat 9, and a fixed hook fastener 12 (attached by an adhesive backing) affixed to the left-side frontal surface of the toddler's safety seat 9.

FIG. 7 is a rendering of a typical infant safety seat 8, with the projected placement and orientation of an oval-contoured travel pillow 20, prior to fastening an infant 10 into the infant safety seat 8.

FIG. 7A illustrates a typical infant safety seat 8 with an infant 10 strapped therein, further showing an oval-contoured travel pillow 20, providing stability to the head and neck area of the infant 10 occupying the child safety seat 8.

FIG. 7B is a stylized image of a toddler's safety seat 9 with the projected placement and orientation of a dish-shaped travel pillow 30 attached to the frontal surface of the toddler's safety seat 9.

FIG. 8 illustrates a typical toddler's safety seat 9 with a toddler 10(a) strapped therein, further showing a dish-shaped travel pillow 30, providing stability to the head and neck area of the toddler 10(a) occupying the toddler's safety seat 9.

Table of Nomenclature & Part Numbers of Invention

1. Travel support pillow
2. Kit
3. Male snap
4. Female snap
5. Loop component
6. Hook component
7. Adhesive
8. Prior Art infant safety seat
9. Prior Art toddler safety seat
10. Infant
10(a) Toddler
11. Seat fastening mechanism
11(a) Right shoulder harness
11(b) Left shoulder harness
12. Fixed hook fastener
12(a) Sewn-in loop fastener
13. Binding strip
14. Protective covering
15. n/a
16. Fixed combination fastener
16(a) Sewn-in combination fastener
17. n/a
18. Cushioning
19. n/a
20. Oval-contoured travel pillow
21. Opening
22. Hollow
23. Recessed cutout
24. Right concave arm
24(a) Right concave arm outer surface
24(b) Right concave arm inner surface
25. Left concave arm
25(a) Left concave arm outer surface
25(b) Left concave arm inner surface
30. Dish-shaped travel pillow
31. Basin
32. Stitching
33. n/a
34. Right shoulder
34(a) Right shoulder outer surface
34(b) Right shoulder inner surface
35. Left shoulder
35(a) Left shoulder outer surface
35(b) Left shoulder inner surface
36.-49. n/a
50. Seat fastening mechanism
51. Shoulder harnesses
52. Crotch area strap

### DETAILED DESCRIPTION OF THE INVENTION

The objects, features, and advantages of the inventive concept presented in this application are more readily understood when referring to the accompanying drawings. The drawings, totaling twenty-two figures, show the basic components and functions of embodiments of the described methods of use. In the several figures, like reference numbers are used in each figure to correspond to the same component as may be depicted in other figures.

The terminology used herein is for the purpose of describing particular embodiments only and is not intended to be limiting of the inventive concept. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

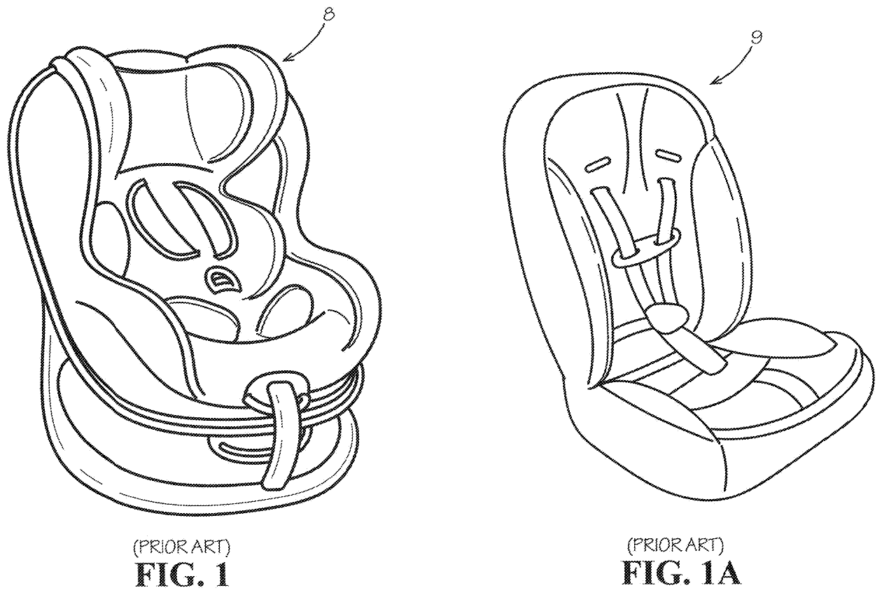

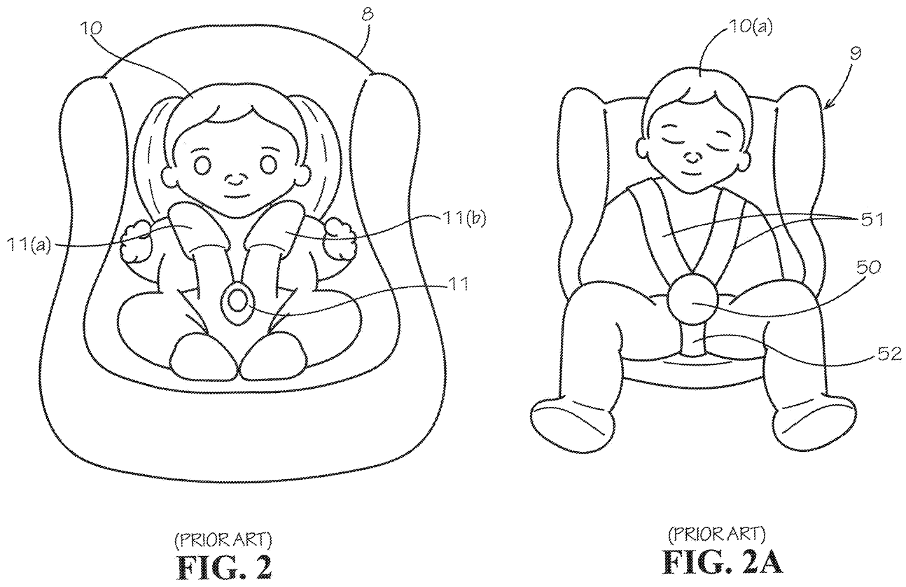

The discussion of the present inventive concept will be initiated with FIG. 1. In FIG. 1 there is presented a view of a prior art infant's car seat 8. FIG 1A shows what is generally referred tows a prior art toddler's car safety seat 9. FIG. 2 depicts a stylized rendering of an infant 10 strapped into the infant's car seat 8 previously shown in FIG. 1. The infant 10 is further secured in the infant's car seat 8 by the usual left and right shoulder harnesses 11(a), 11(b) respectively, and a seat fastening, mechanism 11.

The first level, of motor vehicle safety for infants 10 and toddlers 10(a) is via the vehicle's installed seat belt 50. Because of infants' 10 and toddlers' 10(a) smaller size, a second level of safety should be applied in order to ensure the security and safety of any child, infant, or toddler, during transportation. Prior art devices 8 and 9 are used to indicate this second level of safety and security within a motor vehicle. Added to these car safety seats 8, 9 is the supplemental support of the vehicle's installed seat belt 50.

FIG. 1A and FIG. 2A demonstrate the means by which an infant 10 and/or toddler 10(a) may be transported in a vehicle while strapped into the previously mentioned prior art car safety seats 8, 9. FIG. 2A is a rendering of a child, or toddler 10(a) strapped into a typical toddler's car safety seat 9. The toddler 10(a) is further secured in the toddler's car seat 9 by left and right shoulder harnesses 51, a seat belt fastening mechanism 50, and a crotch area strap 52.

As an effective safety improvement to the infant ear safety seat 8 and the toddler's car safety seat 9, the following disclosure depicts embodiments of an anti-roll travel support pillow, referred to herein as a “travel support pillow 1,” which is included within a packaged kit 2. The travel support pillow 1 included in the kit 2 is distinguished by having diametrically-opposed, equally-shaped, complimentary left and right extension components. Due to the differences in weight, size, and height within the age range of infants to toddlers, there is a requirement for variation in the structure and dimensions of the embodiments of the travel support pillow 1.

The general purpose of the embodiments of the travel support pillow 1 is to prevent injury that may be caused by sudden jerks and oscillations of an infant's or toddler's head and neck area should he or she fall asleep while strapped in either car safety seat 8, 9. With this purpose in mind, a first embodiment of the travel support pillow I is entitled an “oval-contoured travel pillow” 20, while the second embodiment of the travel support pillow is entitled a “dish-shaped travel pillow” 30. When reference is made herein to a travel support pillow 1 in general, this terminology includes both the oval-contoured travel pillow 20 and the dish-shaped travel pillow 30.

In order to provide efficient and variable functional use of the inventive concept discussed herein, consumers will be provided a kit 2 comprising three components: (a) at least one travel support pillow 1, 20, 30, (b) a stand-alone fixed hook fastener 12; and (c) a stand-alone fixed combination fastener 16. It is to be noted that within the kit 2, (not shown) the travel support pillow 1, 20, 30 will have an integral sewn-in loop fastener 12(a) stitched onto the inner surface of the left extension component of the travel support pillow 1, and a sewn-in combination fastener 16(a) stitched onto the inner surface of the right extension component of the travel support pillow 1, 20, 30.

As further discussed herein, the consumer/user, upon accessing the kit 2 packaging, must proceed to attach the fixed hook fastener 12 and the fixed combination fastener 16 to the frontal vertical surface of either an infant seat 8 or a toddler's safety seat 9. Once the steps of attaching the fixed hook fastener 12 and the fixed combination fastener 16 to the infant's or toddler's safety seat 8, 9 is completed, a user is then able to place a child into the car safety seat 8 or 9. Thereupon, at the user's discretion, the user grasps the travel support pillow 1, and first initiates fastening of the combination fastener 16(a) to the fixed combination fastener 16. In the preferred embodiment, the stand-alone fixed hook fastener 12 and fixed combination fastener 16 are integral to a binding strip 13 to which an adhesive substance 7 may be affixed.

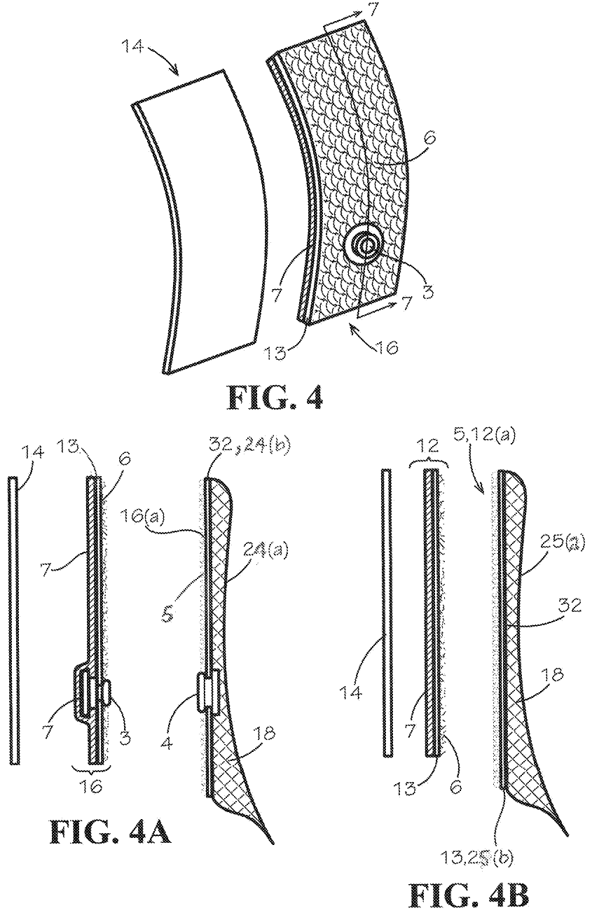

While avoiding placing pressure on the chin area of the infant 10 or toddler 10(a), the user next fastens the sewn-in loop fastener 12(a) onto the fixed hook fastener 12, which has previously been attached to the left frontal vertical surface of the car safety seat 8, 9. When the travel support pillow 1 is placed in position by a user, a slight amount of finger pressure must be applied to place the sewn-in combination fastener 16(a) firmly against both a male snap 3 and the hook component 6 of the fixed hook fastener 12, as can be more readily understood by viewing FIG. 4A.

The user, when unseating the infant 10 or toddler 10(a), may for the sake of convenience, detach only the sewn-in loop fastener 12(a) from its connection to the fixed hook fastener 12 and have the sewn-in combination fastener 16(a) remain connected to the fixed combination fastener 16. The travel support pillow 1 then remains in the vehicle, readily available for its next use.

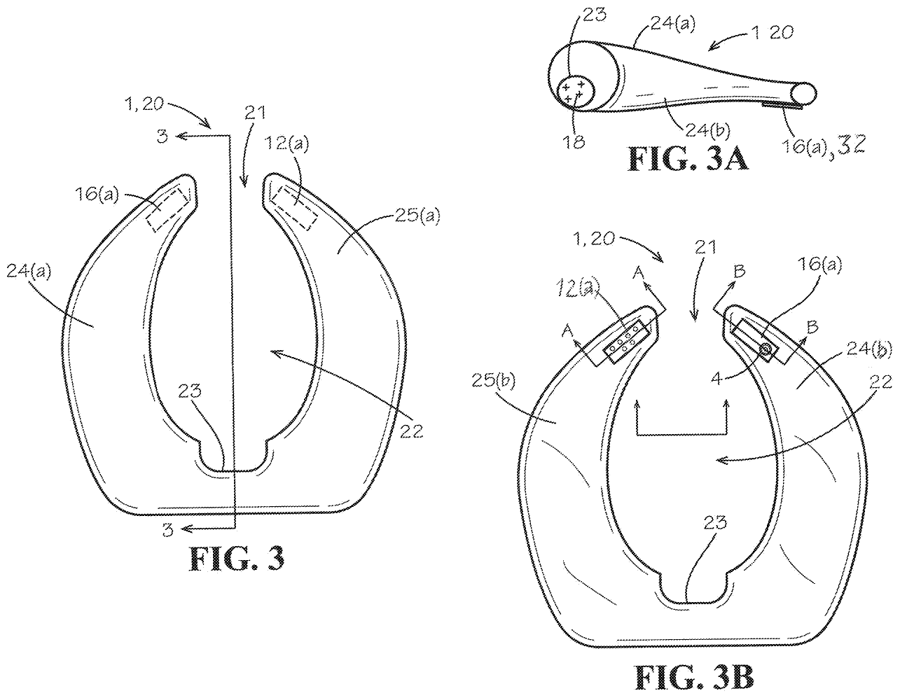

To account for the wide variance in size and weight of a newborn versus an infant or a toddler, the travel support pillow 1, as stated earlier exists in two embodiments: the oval-contoured travel pillow 20, and the dish-shaped travel pillow 30. In viewing FIG. 3, there is shown the frontal, or outer, surfaces of the embodiment of the travel support pillow 1 designated as the oval-contoured pillow 20. FIG. 3 illustrates the construction of the outer surfaces of the right and left extensions of the oval-contoured pillow 20.

Specifically shown in FIG. 3 are the outer surface 24(a) of the right concave arm 24 and the outer surface 25(a) of the left concave arm 25. The right concave arm 24 and left concave arm 25, are both joined at a rectangular-shaped cutout 23, the arms 24, 25 thereby forming an elliptical hollow 22, thereby comprising the oval-contoured pillow 20. The elliptical hollow 22 is intended to accommodate an infant's neck area. Further shown is a narrow opening 21, which facilitates a person maneuvering the right concave arm 24 and/or left concave arm 25 of the oval-contoured pillow 20 during attachment to, and/or release from, either an infant's safety seat 8 or a toddler's safety seat 9.

FIG. 3A presents a cross-sectional view of the oval-contoured pillow 20, as seen from section line 3-3 of FIG. 3. FIG. 3A illustrates the outer surface 24(a) of the right concave arm 24 and the inner surface 24(b) of the right concave arm 24. Further shown in FIG. 3A is a cross-sectional view of the cutout 23 and the interior cushioning 18 of the recessed cutout 23. The recessed cutout 23 is positioned proximate a child's or toddler's neck area when in use. The recessed cutout 23 is a common structural point integral to the entire oval contoured travel pillow 20. Also shown in FIG. 3A is an attached, sewn-in combination fastener 16(a).

FIG. 3B presents views of a sewn-in loop fastener 12(a) and a sewn-in combination fastener 16(a). Both the sewn-in loop fastener 12(a) and the sewn-in combination fastener 16(a) are securely sewn into the inner surfaces of the oval-contoured pillow 20. Specifically shown are the left inner surface 25(b) of the left concave arm 25, and the right inner surface 24(b) of the right concave arm 24. Both inner surfaces 25(b), 24(b) of the oval-contoured travel pillow 20 may be constructed within a range of dimensions and measurements so as fit comfortably proximate the chin and neck area of an infant 10.

The oval-contoured travel pillow 20 of FIG. 3B is depicted as having a sewn-in loop fastener 12(a) which consists of a thin binding strip 13, the binding strip 13 covered completely on its outer side by the loop component 5 of a hook-and-loop fastening mechanism. The sewn-in loop fastener 12(a) is joined to the end of the inner surface 25(b) of the left concave arm 25 by stitching 32 the sewn-in loop fastener 12(a) onto the left concave arm 25. The location and orientation of the sewn-in loop fastener 12(a) is more readily understood by viewing the rightmost illustration in FIG. 4B.

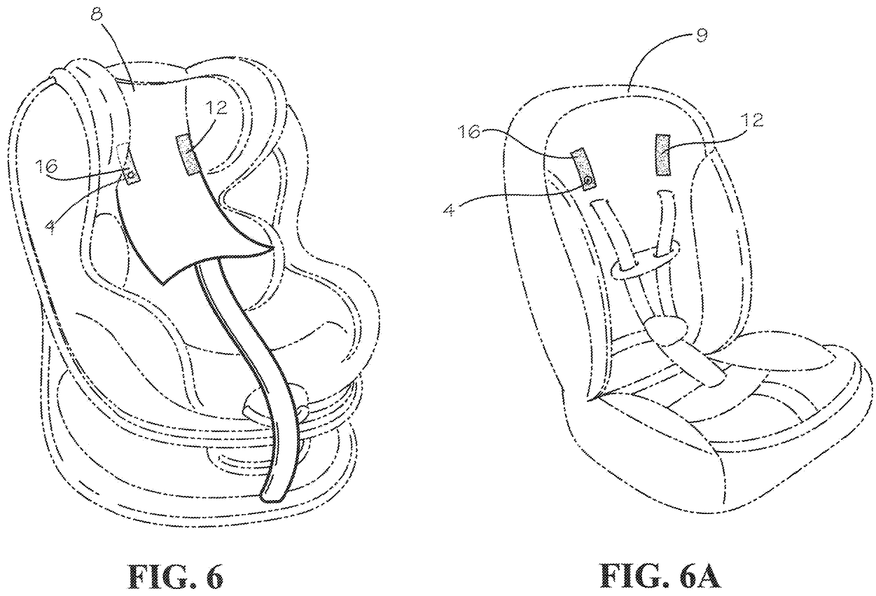

When the oval-contoured travel pillow 20 is placed in use, the sewn-in loop fastener 12(a) will be detachably connected to a fixed hook fastener 12, which fixed hook fastener 12 has previously been attached (in the preferred embodiment, adhesively) to either an infant's child seat 8 or a toddler's safety seat 9. The location and orientation of the fixed hook fastener 12 is more clearly displayed in FIG. 6 and FIG. 6A, herein,

Turning to FIG. 4, the leftmost illustration depicts a separated protective covering 14, having been removed from its attachment to an adhesive layer 7 integral to a fixed combination fastener 16. The adhesive layer 7 is also shown in the center illustration of FIG. 4A, which is a cross-sectional view of the fixed combination fastener 16, according to section line 7-7 of FIG. 4. Moreover, the center illustration of FIG. 4A shows the preferred embodiment, where an adhesive layer 7, is integral to one side of a binding strip 13, the binding strip 13 further housing the hook component 6 of a hook-and-loop fastening means.

Upon a user removing the protective covering 14, the resultant mechanism is the fixed combination fastener 16, shown in the center illustration of FIG. 4. The fixed combination fastener 16 is a unique combination of the hook component 6 of a hook-and-loop fastener and a male snap 3, as shown. The fixed combination fastener 16 is thereby readied for adhesively attaching (by means of the adhesive 7) to the exterior front hard surface of an infant safety seat 9 or a toddler safety seat 9.

The rightmost illustration of FIG. 4A presents a cross-sectional view of a small section of the right concave arm 24 of the oval-contoured travel pillow 20, as seen from section line B-B of FIG. 3B. As observed in the rightmost illustration of FIG. 4A, there is depicted the sewn-in combination fastener 16(a) affixed with stitches 32, to the right inner surface 24(b) of the right concave arm 24 of the oval-contoured travel pillow 20, The sewn-in combination fastener 16(a) is a unique combination of the loop component 5 of a hook-and-loop fastening mechanism, along with a female snap 4. The inventive concept is constructed such that the sewn-in combination fastener 16(a) is matched to fit connectively to the fixed combination fastener 16 and its male snap 3. The positioning of the fixed combination fastener 16 is more readily visualized in FIG. 6 and FIG. 6A, below,

In viewing FIG. 4B, the leftmost illustration depicts a protective covering 14 having been separated from the adhesive layer 7 of a fixed hook fastener 12. The center illustration of FIG. 4B is a cross-sectional view as seen from the perspective of section line A-A of FIG. 313. The fixed hook fastener 12, shown in the center illustration of FIG. 4B, has a binding strip 13 containing the hook component 6 of a hook-and-loop fastening mechanism integral to one side of the binding strip 13, with an adhesive substance 7 on the opposite side of the binding strip 13.

Upon a user separating the protective covering 14, from the fixed hook fastener 12, the fixed hook fastener 12 is then readied for adhesively attaching (by means of the adhesive) to the exterior front hard surface of either an infant safety seat 8 or a toddler safety seat 9. Examples of the positioning of the fixed hook fastener 12 on a safety seat are more readily visualized in both FIG. 6 and FIG. 6A, below.

It is important to note that both the fixed combination fastener 16 and the fixed hook fastener 12 are two separate, stand-alone items contained in a user's kit 2, both of which must be removed from the kit 2 (not shown) and placed upon the right frontal vertical surface and the left frontal vertical surface, respectively, of an infant safety seat 9 or a toddler safety seat 9.

The rightmost illustration of FIG. 4B depicts a cross-sectional view of a sewn-in loop fastener 12(a), including its binding strip 13, stitching 32, and integral loop component 5 of a hook-and-loop fastening mechanism. The sewn-in loop fastener 12(a) is stitched to the inner surface 25(b) of the left concave arm 25 of an oval-contoured travel pillow 20. The sewn-in loop fastener 12(a) is attached, at its binding strip 13, by stitching 32 to the left concave arm 25. FIG. 4B is seen from the perspective of section line A-A of FIG. 3B.

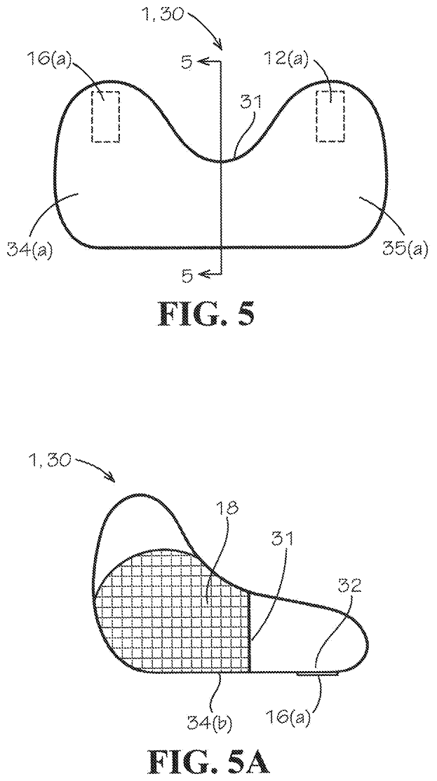

FIG. 5 illustrates an embodiment of the travel support pillow 1, the embodiment shown designated as a “dish-shaped travel pillow” 30. FIG. 5 is a planar view of the outer surface of the dish-shaped travel pillow. The form and construction of the dish-shaped travel pillow 30 illustrated in FIG. 5 shows a right extension component, termed a “right shoulder 34, where the right shoulder outer surface 34(a) is visible. Further, the dish-shaped travel pillow 30 has a symmetrically-placed left extension component, termed a left shoulder 35 the left shoulder outer surface 35(a) is visible.

A curvilinear basin 31 is also shown, the basin 31 being the area proximate a toddler's chin and neck when the dish-shaped travel pillow 30 is placed in service. Out of view, at the curved tip of the right shoulder inner surface 34(b), is attached a sewn-in combination fastener 16(a). Also out of view, at the curved tip of the left shoulder inner surface 35(b), is attached a sewn-in loop fastener 12(a).

FIG. 5A depicts a cross-sectional view of the dish-shaped travel pillow 30, as seen from the perspective of section lines 5-5 of FIG. 5. FIG. 5A shows more clearly the placement of the sewn-in combination fastener 16(a), as attached by stitching 32, to the right shoulder inner surface 34(b). Further shown in FIG. 5A is the interior cushioning 18 material, which is integral to the entirety of the dish-shaped travel pillow 30.

The sewn-in combination fastener 16(a) is a unique combination of the loop component 5 of a hook-and-loop fastening mechanism, along with a female snap 4. The sewn-in combination fastener 16(a) is more readily understood by viewing FIG. 4A herein. The sewn-in combination fastener 16(a) is constructed so as to correspondingly fit connectively onto to the fixed combination fastener 16 and its male snap 3. For ease of operation, when the dish-shaped travel pillow 30 is placed in use, the user should first connect the sewn-in combination fastener 16(a) to a fixed combination fastener 16 which has previously been attached to either an infant's safety seat 8 or a toddler safety seat 9.

In the preferred method of operation, a user, as the last step in the use of the dish-shaped travel pillow 30, will place the sewn-in loop fastener 12(a) in attachment to fixed hook fastener 12, which fixed hook fastener 12 has been previously adhesively attached to either an infant's child seat 8 or a toddler's safety seat 9. The location and orientation of the fixed hook fastener 12 is more clearly displayed in FIG. 6 and FIG. 6A, herein. The connection of both the sewn-in combination fastener 16(a) and the connection of the sewn-in loop fastener 12(a), should be accomplished after the toddler has been placed into the toddler's safety seat 9.

When accessing either embodiment of the travel support pillow 1 from its packaging as a kit 2, a user must first remove the upholstered covering (if any) from the upper section of either an infant safety seat 8 or a toddler's safety seat 9. Thereupon, the user separates the protective covering 14 from the adhesive 7 backing of a fixed combination fastener 16. The fixed combination fastener 16 is then placed on the right frontal vertical surface of the infant safety seat 8 or the toddler's safety seat 9.

The user next separates the protective covering 14 from the adhesive 7 backing of a fixed hook fastener 12. The fixed hook fastener 12 is then also placed on the left frontal vertical surface of the infant safety seat 8 or the toddler's safety seat 9. The user must follow the written instructions for use of the adhesive 7 as indicated in the kit 2. The kit 2 (not shown) is essentially packaging containing the working components of the inventive concept. The placement of the fixed combination fastener 16 and fixed hook fastener 12 are illustrated in FIG. 6 and FIG. 6A.

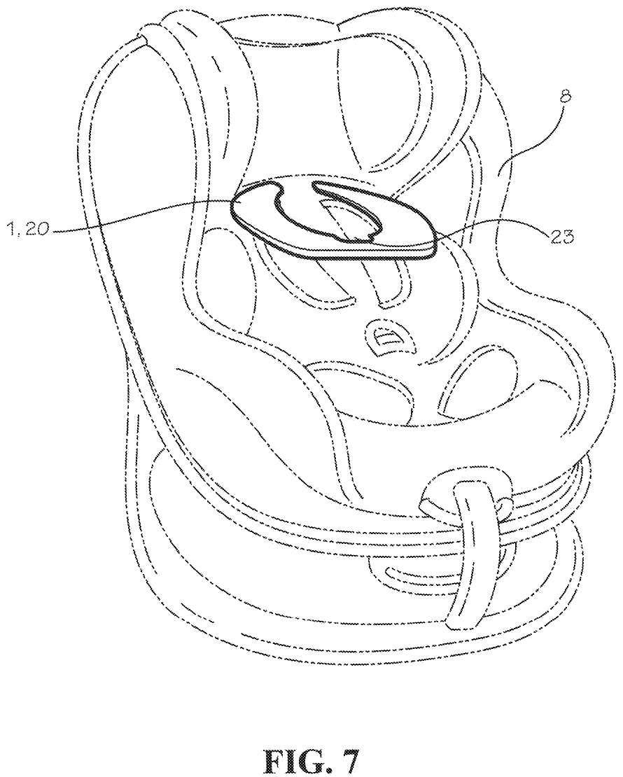

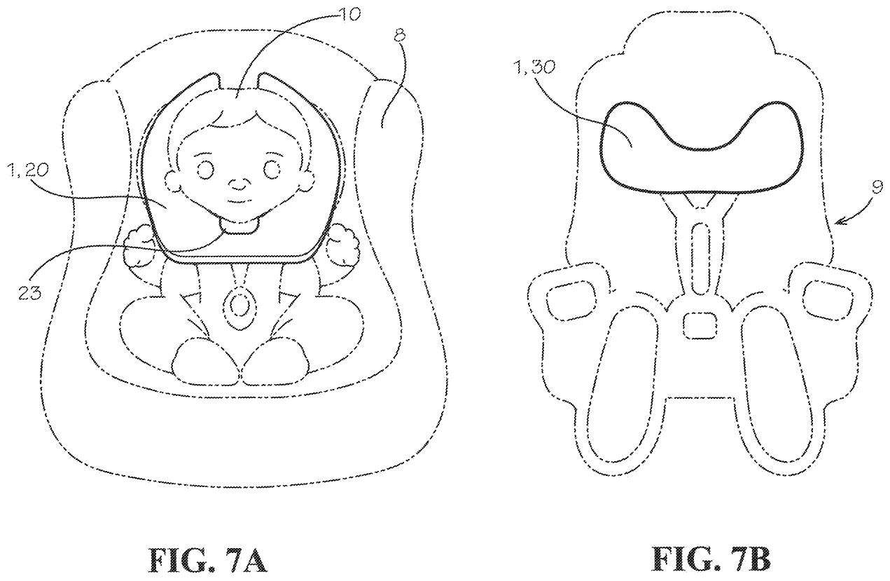

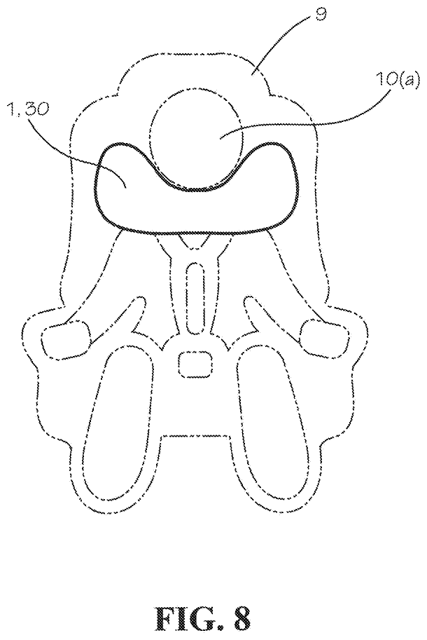

In some circumstances a user must remove and afterwards, replace the seat cushion covering of certain car models. The oval-contoured travel pillow 20 supports the infant's 10 head when the oval-contoured pillow 20 is mounted underneath the chin, behind the ears, and proximate the neck area, as indicated in FIG. 7A. The chin is cradled in the cutout 23 area, thereby providing an airflow gap, so as not to apply any pressure around the infant's throat area when in use. The infant's 10 oval-contoured travel pillow 20 is designed to provide a limited range of motion of the infant's 10 head, minimizing stress to neck, head, and spine while the vehicle is in motion. Further, bracing support is provided for the infant 10 during any sudden impact that could potentially he severe for the infant 10.

When not needed, the oval-contoured travel pillow 20 or the dish-shaped travel pillow 30 may be pulled apart to release support from a child or toddler's neck area by unsnapping the sewn-in combination fastener 16(a) from its connection to the female snap 7 of the fixed combination fastener 16. To re-connect, it is only necessary to press these two connecting mechanisms together again. The design of the travel support pillows 20, 30 also makes it easy for a toddler to unhook the connection When he or she awakens, without the assistance of another person.

While preferred embodiments of the present inventive method have been shown and disclosed herein, it Will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. A travel kit for deploying a travel support pillow proximate the head and neck area of a toddler or child when the toddler is occupying a toddler's or child safety seat, the kit comprising (a) at least one travel support pillow having an integral, distinct left extension component, and an integral, distinct right extension component, the left extension component having a sewn-in loop fastener and the right extension component having a sewn-in combination fastener (b) at least one stand-alone fixed hook fastener 12; and (c) at least one stand-alone fixed combination fastener.

2. The travel kit of claim 1, wherein the at least one travel support pillow comprises a dish-shaped travel pillow, wherein the left extension component comprises a left shoulder and the right extension component comprises a right shoulder, both the left shoulder and the right shoulder being joined at a segment of the dish-shaped travel pillow which forms a basin, said basin enabling accommodation of the neck and chin area of the toddler or child.

3. The travel kit of claim 1, wherein the at least one travel support pillow comprises a loop fastener sewn onto the inner surface of the left extension component, and a combination fastener sewn onto the inner surface of the right extension component.

4. The travel kit of claim 1, wherein (a) the sewn-in loop fastener comprises the loop component of a hook-and-loop fastening mechanism integral to one side of a binding strip, the opposite of the binding strip stitched to the travel pillow; (b) the sewn-in combination fastener comprises the loop component of a hook-and-loop fastening mechanism integral to one side of a binding strip, wherein the binding strip further houses a female snap; (c) the stand-alone fixed hook fastener comprises the hook component of a hook-and-loop fastening mechanism integral to one side of a binding strip, with an adhesive substance attached to the opposite side of the binding strip; and (d) the stand-alone fixed combination fastener comprises the hook component of a hook-and-loop fastening mechanism integral to one side of a binding strip with an adhesive substance attached to the other side of the binding strip, and further, the binding strip houses a male snap.

5. A method of providing safety and stabilization for the neck and head of a toddler or child while the toddler or child is enclosed in a toddler or child's safety seat within a vehicle, the method comprising the steps of
(a) providing a child or toddler's safety seat having a left frontal vertical surface and a right frontal vertical surface;
(b) providing a stand-alone fixed hook fastener and attaching same to the left-frontal vertical surface of the toddler or child's safety seat;
(c) providing a stand-alone fixed combination fastener (female) and attaching same to the right frontal vertical surface of the toddler or child's safety seat;
(d) providing a travel support pillow having (i) an integral, distinct left extension component, (ii) an integral, distinct right extension component, and (iii) a basin;
(e) affixing, by means of stitching, a sewn-in loop fastener to the inner surface of the left extension component;
(f) affixing, by means of stitching, a sewn-in combination fastener to the inner surface of the right extension component;
(g) upon initiating use of the travel support pillow, attaching the sewn-in loop fastener of the travel support pillow to the stand-alone fixed hook fastener previously affixed to the toddler or child's safety seat;
(h) placing a toddler or child into the safety seat, and securing chest and leg restraints;
(i) placing the recessed cutout of the travel support pillow proximate the neck and chin of the toddler or child; and
(j) attaching the sewn-in combination fastener of the travel support pillow to the fixed combination fastener, previously affixed to the toddler or child safety seat.

6. The method of claim 5, wherein
(a) the at least one travel support pillow is a dish-shaped travel pillow, wherein the left extension component comprises a left shoulder and the right extension component comprises a right shoulder,
(b) the sewn-in loop fastener comprises the loop component of a hook-and-loop fastening mechanism integral to one side of a binding strip, the opposite side of the binding strip being stitched to the inner surface of the left shoulder;
(c) the sewn-in combination fastener comprises the loop component of a hook-and-loop fastening mechanism integral to one side of a binding strip, wherein the opposite side of the binding strip is stitched to the inner surface of the right shoulder, the binding strip further housing a female snap;
(d) the stand-alone fixed hook fastener comprises the hook component of a hook-and-loop fastening mechanism integral to one side of a binding strip, with an adhesive substance attached to the opposite side of the binding strip; and
(e) the stand-alone fixed combination fastener comprises the hook component of a hook-and-loop fastening mechanism integral to one side of a binding strip with an adhesive substance attached to the other side of the binding strip, and further, the binding strip housing a male snap.

7. A travel kit for deploying a travel support pillow proximate the head and neck area of a toddler or child, when the toddler or child is occupying an infant or child safety seat, the kit comprising (a) at least one oval-contoured travel pillow; (h) at least one dish-shaped travel pillow, (c) at least two stand-alone fixed hook fasteners; and (d) at least two stand-alone fixed combination fasteners.
